(19) United States
(12) Patent Application Publication
(10) Pub. No.: US 2014/0092977 A1
(43) Pub. Date: Apr. 3, 2014

(54) Apparatus, a Method and a Computer Program for Video Coding and Decoding

(71) Applicant: Nokia Corporation, Espoo (FI)

(72) Inventors: Jani Lainema, Tampere (FI); Miska Matias Hannuksela, Tampere (FI); Mehmet Oguz Bici, Tampere (FI); Kemal Ugur, Tampere (FI)

(73) Assignee: Nokia Corporation, Espoo (FI)

(21) Appl. No.: 14/039,110

(22) Filed: Sep. 27, 2013

Related U.S. Application Data
(60) Provisional application No. 61/707,031, filed on Sep. 28, 2012.

(51) Int. Cl. H04N 7/36

(52) U.S. Cl. CPC H04N 19/00587
USPC 375/240.16

(57) ABSTRACT

In some embodiments, there is provided an apparatus, a computer readable storage medium stored with code thereon for use by an apparatus, and a video decoder, for decoding a video bitstream, to derive a motion compensated prediction for an enhancement layer block based on a motion compensation process on the co-located base layer block using the same or similar motion vector of enhancement layer blocks and base layer reference pictures. In other embodiments, there is provided a method, an apparatus, a computer readable storage medium stored with code thereon for use by an apparatus, and a video encoder, for encoding a video bitstream, to derive a motion compensated prediction for an enhancement layer block based on a motion compensation process on the co-located base layer block using the same or similar motion vector of enhancement layer blocks and base layer reference pictures.

### TECHNICAL FIELD

The present invention relates to an apparatus, a method and a computer program for video coding and decoding.

### BACKGROUND INFORMATION

A video codec may comprise an encoder which transforms input video into a compressed representation suitable for storage and/or transmission and a decoder that can uncompress the compressed video representation back into a viewable form, or either one of them. Typically, the encoder discards some information in the original video sequence in order to represent the video in a more compact form, for example at a lower bit rate.

Scalable video coding refers to coding structure where one bitstream can contain multiple representations of the content at different bitrates, resolutions or frame rates. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers.

A scalable video codec for quality scalability (also known as Signal-to-Noise or SNR) and/or spatial scalability may be implemented as follows. For a base layer, a conventional non-scalable video encoder and decoder are used. The reconstructed/decoded pictures of the base layer are included in the reference picture buffer for an enhancement layer. In codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use typically with a reference picture index in the coded bitstream. The decoder decodes from the bitstream, for example from a reference picture index, that a base-layer picture is used as inter prediction reference for the enhancement layer.

In addition to quality scalability, scalability can be achieved through spatial scalability, where base layer pictures are coded at a higher resolution than enhancement layer pictures, bit-depth scalability, where base layer pictures are coded at lower bit-depth (e.g. 8 bits) than enhancement layer pictures (e.g. 10 or 12 bits), and chroma format scalability, where base layer pictures provide higher fidelity in chroma (e.g. coded in 4:4:4 chroma format) than enhancement layer pictures (e.g. 4:2:0 format).

In all of the above scalability cases, base layer information could be used to code enhancement layer to minimize the additional bitrate overhead. Nevertheless, the existing solutions for scalable video coding do not take full advantage of the information available from the base layer and from the enhancement layer when encoding and decoding the enhancement layer.

### SUMMARY

This invention proceeds from the consideration that in order to improve the performance of the enhancement layer motion compensated prediction, the enhancement layer motion compensated prediction and a differential signal estimated by a motion compensation process on the base layer using the same or similar motion vector of enhancement layer are added together.

A method for encoding a block of samples in an enhancement layer picture according to a first embodiment comprises
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to an embodiment, the method further comprises
identifying a residual signal between the values of the block of samples in an original picture and the values of the second enhancement layer prediction;
coding the residual signal into a reconstructed residual signal; and
adding the reconstructed residual signal to the second enhancement layer prediction.

According to an embodiment, indication of the inter prediction modes and corresponding motion vectors and reference frame indexes is carried out similarly to the HEVC.

According to an embodiment, the blocks in the base layer are generated by upsampling samples of the base layer picture to have the same spatial resolution as the enhancement layer prediction block.

According to an embodiment, the base layer motion compensated prediction and deduction of the base layer motion compensated prediction from the base layer reconstructed samples is performed prior to upsampling the difference and adding it to the enhancement layer prediction.

According to an embodiment, the motion compensated prediction in the base layer is created using the at least one base layer reference picture upsampled to the same spatial resolution as the enhancement layer prediction block.

According to an embodiment, the difference of the block of reconstructed samples in a base layer picture and the samples of a co-located base layer prediction block is scaled by at least one scaling factor.

According to an embodiment, the said scaling factor is signaled in the bitstream.

According to an embodiment, a number of predefined scaling factors are used and the scaling factors are indicated in the bitstream.

According to an embodiment, if coordinate systems of the enhancement and base layer images are different, a difference in a spatial scalability between the base layer and enhancement layer is taken into account, when defining a relationship of coordinates of the base and enhancement layer samples.

According to an embodiment, the enhancement layer motion information is scaled to match the difference in a spatial scalability between the base layer and enhancement layer prior to performing the base layer motion compensated prediction.

According to an embodiment, using intermediate samples prior to reconstruction, instead of reconstructed base layer samples, for obtaining the difference values.

According to an embodiment, using base layer values prior to in-loop filtering operations, such as deblocking filtering or Sample Adaptive Offset (SAO) and Adaptive Loop Filter (ALF).

According to an embodiment, the method is applied always as a default setting.

According to an embodiment, the method is enabled selectively by signaling a flag to the decoder.

According to an embodiment, the method is enabled by signaling a one-bin identifier at Prediction Unit (PU) level

According to an embodiment, the method is enabled when pre-determined conditions are met, such as based on the modes of the neighboring blocks, based on presence of prediction error coding on the base layer block(s) with location corresponding to the enhancement layer block, based on the sample values of the enhancement layer or base layer reference frames or sample values of the reconstructed base layer picture, availability of the base layer reference picture in the base layer decoded picture buffer or a combination of these.

An apparatus according to a second embodiment comprises:
a video encoder configured for encoding a scalable bitstream comprising a base layer and at least one enhancement layer, wherein said video encoder is further configured for
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to a third embodiment there is provided a computer readable storage medium stored with code thereon for use by an apparatus, which when executed by a processor, causes the apparatus to perform:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture; and
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to a fourth embodiment there is provided at least one processor and at least one memory, said at least one memory stored with code thereon, which when executed by said at least one processor, causes an apparatus to perform:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

A method according to a fifth embodiment comprises a method for decoding a scalable bitstream comprising a base layer and at least one enhancement layer, the method comprising
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture and the enhancement layer motion information;
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

According to an embodiment, the method further comprises
identifying a residual signal between the values of the block of samples in an original picture and the values of the second enhancement layer prediction;
decoding the residual signal into a reconstructed residual signal; and
adding the reconstructed residual signal to second enhancement layer prediction.

According to an embodiment, indication of the inter prediction modes and corresponding motion vectors and reference frame indexes is carried out similarly to the HEVC.

According to an embodiment, the blocks in the base layer are generated by upsampling samples of the base layer picture to have the same spatial resolution as the enhancement layer prediction block.

According to an embodiment, the base layer motion compensated prediction and deduction of the base layer motion compensated prediction from the base layer reconstructed samples is performed prior to upsampling the difference and adding it to the enhancement layer prediction.

According to an embodiment, the motion compensated prediction in the base layer is created using the at least one base layer reference picture upsampled to the same spatial resolution as the enhancement layer prediction block.

According to an embodiment, the difference of the block of reconstructed samples in a base layer picture and the samples of a co-located base layer prediction block is scaled by at least one scaling factor.

According to an embodiment, the said scaling factor is signaled in the bitstream.

According to an embodiment, a number of predefined scaling factors are used and the scaling factors are indicated in the bitstream.

According to an embodiment, if coordinate systems of the enhancement and base layer images are different, a difference in a spatial scalability between the base layer and enhancement layer is taken into account, when defining a relationship of coordinates of the base and enhancement layer samples.

According to an embodiment, the enhancement layer motion information is scaled to match the difference in a spatial scalability between the base layer and enhancement layer prior to performing the base layer motion compensated prediction.

According to an embodiment, using intermediate samples prior to reconstruction, instead of reconstructed base layer samples, for obtaining the difference values.

According to an embodiment, using base layer values prior to in-loop filtering operations, such as deblocking filtering or Sample Adaptive Offset (SAO) and Adaptive Loop Filter (ALF).

According to an embodiment, the method is applied always as a default setting.

According to an embodiment, the method is enabled selectively upon reception of a flag.

According to an embodiment, the method is enabled upon reception of a one-bin identifier at Prediction Unit (PU) level.

According to an embodiment, the method is enabled when pre-determined conditions are met, such as based on the modes of the neighboring blocks, based on presence of prediction error coding on the base layer block(s) with location corresponding to the enhancement layer block, based on the sample values of the enhancement layer or base layer reference frames or sample values of the reconstructed base layer picture, availability of the base layer reference picture in the base layer decoded picture buffer or a combination of these.

An apparatus according to a sixth embodiment comprises:
a video decoder configured for decoding a scalable bitstream comprising a base layer and at least one enhancement layer, the video decoder being configured for
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

According to a seventh embodiment there is provided a video encoder configured for encoding a scalable bitstream comprising a base layer and at least one enhancement layer, wherein said video encoder is further configured for:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to an eighth embodiment there is provided a video decoder configured for decoding a scalable bitstream comprising a base layer and at least one enhancement layer, wherein said video decoder is further configured for:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

### DESCRIPTION OF THE DRAWINGS

For better understanding of the present invention, reference will now be made by way of example to the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4 shows schematically an encoder suitable for implementing some embodiments of the invention;

FIG. 5 shows an example of a picture consisting of two tiles;

FIG. 6 shows a flow chart of an encoding/decoding process according to some embodiments of the invention;

FIG. 7 shows an example of base enhanced motion compensated prediction according an embodiment of the invention; and

FIG. 8 shows a schematic diagram of a decoder according to some embodiments of the invention.

### DETAILED DESCRIPTION OF SOME EXAMPLE EMBODIMENTS OF THE INVENTION

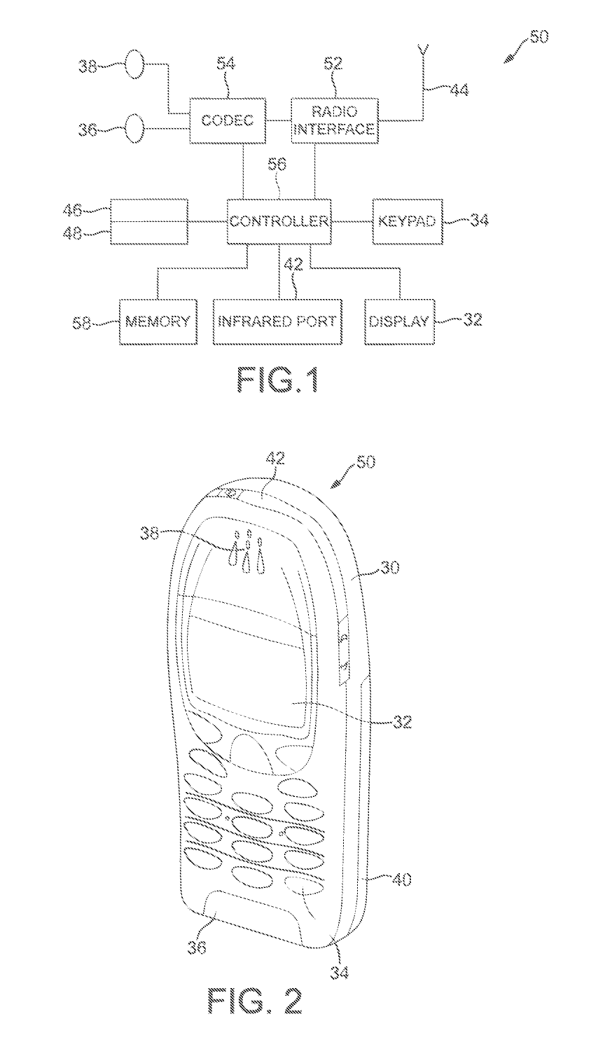

The following describes in further detail suitable apparatus and possible mechanisms for encoding an enhancement layer sub-picture without significantly sacrificing the coding efficiency. In this regard reference is first made to FIG. 1 which shows a schematic block diagram of an exemplary apparatus or electronic device 50, which may incorporate a codec according to an embodiment of the invention.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In other embodiments of the invention, the apparatus may receive the video image data for processing from another device prior to transmission and/or storage. In other embodiments of the invention, the apparatus 50 may receive either wirelessly or by a wired connection the image for coding/decoding.

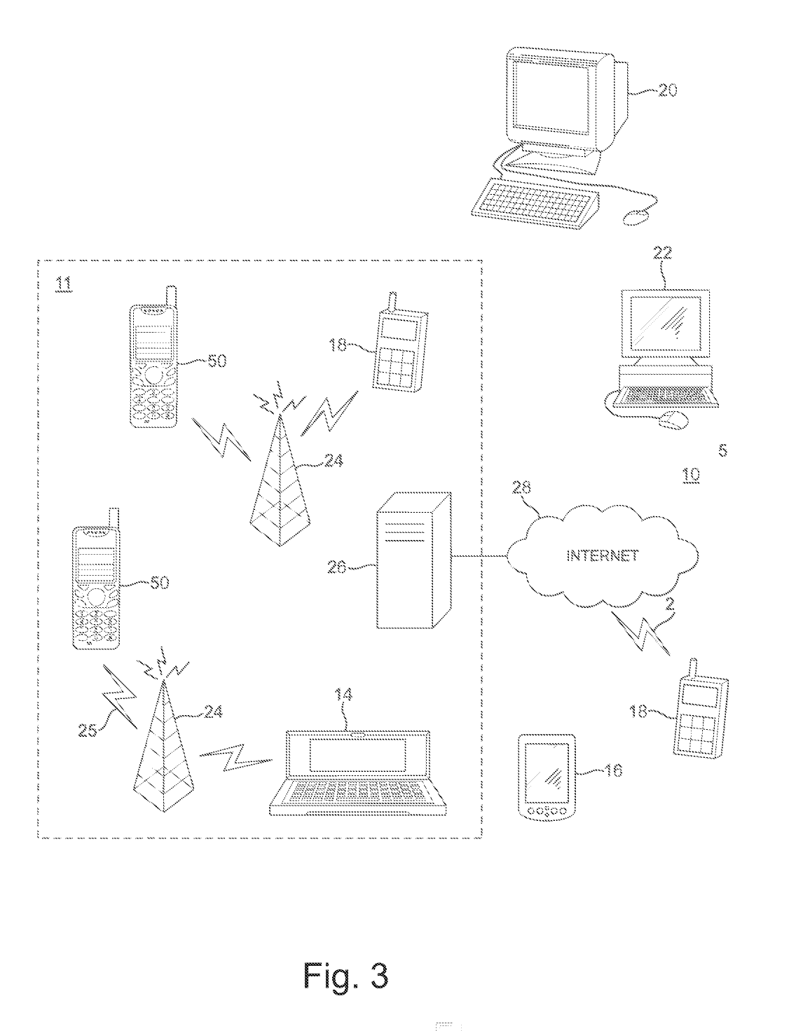

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware or software or combination of the encoder/decoder implementations, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Video codec consists of an encoder that transforms the input video into a compressed representation suited for storage/transmission and a decoder that can uncompress the compressed video representation back into a viewable form. Typically encoder discards some information in the original video sequence in order to represent the video in a more compact form (that is, at lower bitrate).

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Video coding is typically a two-stage process: First, a prediction of the video signal is generated based on previous coded data. Second, the residual between the predicted signal and the source signal is coded. Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

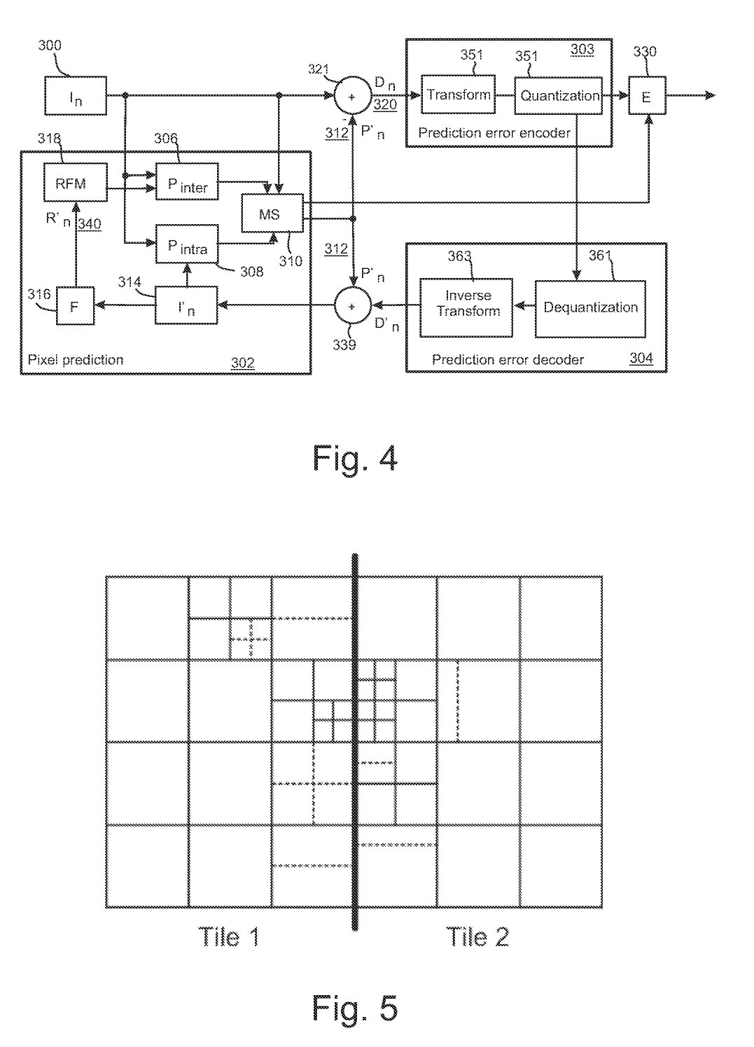

With respect to FIG. 4, a block diagram of a video encoder suitable for carrying out embodiments of the invention is shown. FIG. 4 shows the encoder as comprising a pixel predictor 302, prediction error encoder 303 and prediction error decoder 304. FIG. 4 also shows an embodiment of the pixel predictor 302 as comprising an inter-predictor 306, an intra-predictor 308, a mode selector 310, a filter 316, and a reference frame memory 318. The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the image 300.

Depending on which encoding mode is selected to encode the current block, the output of the inter-predictor 306 or the output of one of the optional intra-predictor modes or the output of a surface encoder within the mode selector is passed to the output of the mode selector 310. The output of the mode selector is passed to a first summing device 321. The first summing device may subtract the output of the pixel predictor 302 from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which a future image 300 is compared in inter-prediction operations.

The operation of the pixel predictor 302 may be configured to carry out any known pixel prediction algorithm known in the art.

The prediction error encoder 303 comprises a transform unit 342 and a quantizer 344. The transform unit 342 transforms the first prediction error signal 320 to a transform domain. The transform is, for example, the DCT transform. The quantizer 344 quantizes the transform domain signal, e.g. the DCT coefficients, to form quantized coefficients.

The prediction error decoder 304 receives the output from the prediction error encoder 303 and performs the opposite processes of the prediction error encoder 303 to produce a decoded prediction error signal 338 which, when combined with the prediction representation of the image block 312 at the second summing device 339, produces the preliminary reconstructed image 314. The prediction error decoder may be considered to comprise a dequantizer 361, which dequantizes the quantized coefficient values, e.g. DCT coefficients, to reconstruct the transform signal and an inverse transformation unit 363, which performs the inverse transformation to the reconstructed transform signal wherein the output of the inverse transformation unit 363 contains reconstructed block(s). The prediction error decoder may also comprise a macroblock filter which may filter the reconstructed macroblock according to further decoded information and filter parameters.

The entropy encoder 330 receives the output of the prediction error encoder 303 and may perform a suitable entropy encoding/variable length encoding on the signal to provide error detection and correction capability.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC). There is a currently ongoing standardization project of High Efficiency Video Coding (HEVC) by the Joint Collaborative Team-Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

In the description of existing standards as well as in the description of example embodiments, a syntax element may be defined as an element of data represented in the bitstream. A syntax structure may be defined as zero or more syntax elements present together in the bitstream in a specified order.

A profile may be defined as a subset of the entire bitstream syntax that is specified by a decoding/coding standard or specification. Within the bounds imposed by the syntax of a given profile it is still possible to require a very large variation in the performance of encoders and decoders depending upon the values taken by syntax elements in the bitstream such as the specified size of the decoded pictures. In many applications, it might be neither practical nor economic to implement a decoder capable of dealing with all hypothetical uses of the syntax within a particular profile. In order to deal with this issue, levels may be used. A level may be defined as a specified set of constraints imposed on values of the syntax elements in the bitstream and variables specified in a decoding/coding standard or specification. These constraints may be simple limits on values. Alternatively or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles.

The elementary unit for the input to an H.264/AVC or HEVC encoder and the output of an H.264/AVC or HEVC decoder, respectively, is a picture. In H.264/AVC and HEVC, a picture may either be a frame or a field. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In some video codecs, such as High Efficiency Video Coding (HEVC) codec, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

The directionality of a prediction mode, i.e. the prediction direction to be applied in a particular prediction mode, may be vertical, horizontal, diagonal. For example, in the current HEVC draft codec, unified intra prediction provides up to 34 directional prediction modes, depending on the size of Pus, and each of the intra prediction modes has a prediction direction assigned to it.

Similarly each TU is associated with information describing the prediction error decoding process for the samples within the said TU (including e.g. DCT coefficient information). It is typically signalled at CU level whether prediction error coding is applied or not for each CU. In the case there is no prediction error residual associated with the CU, it can be considered there are no TUs for the said CU. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In a draft HEVC standard, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order. FIG. 5 shows an example of a picture consisting of two tiles partitioned into square coding units (solid lines) which have been further partitioned into rectangular prediction units (dashed lines).

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

C=D+λR, (1)

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

Coded slices can be categorized into three classes: raster-scan-order slices, rectangular slices, and flexible slices.

A raster-scan-order-slice is a coded segment that consists of consecutive macroblocks or alike in raster scan order. For example, video packets of MPEG-4 Part 2 and groups of macroblocks (GOBs) starting with a non-empty GOB header in H.263 are examples of raster-scan-order slices.

A rectangular slice is a coded segment that consists of a rectangular area of macroblocks or alike. A rectangular slice may be higher than one macroblock or alike row and narrower than the entire picture width. H.263 includes an optional rectangular slice submode, and H.261 GOBs can also be considered as rectangular slices.

A flexible slice can contain any pre-defined macroblock (or alike) locations. The H.264/AVC codec allows grouping of macroblocks to more than one slice groups. A slice group can contain any macroblock locations, including non-adjacent macroblock locations. A slice in some profiles of H.264/AVC consists of at least one macroblock within a particular slice group in raster scan order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit and whether a coded slice contained in the NAL unit is a part of a reference picture or a non-reference picture.

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC standard includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units may additionally contain various indications related to the scalability and multiview hierarchy.

In a draft HEVC standard, a two-byte NAL unit header is used for all specified NAL unit types. The first byte of the NAL unit header contains one reserved bit, a one-bit indication nal_ref_flag primarily indicating whether the picture carried in this access unit is a reference picture or a non-reference picture, and a six-bit NAL unit type indication. The second byte of the NAL unit header includes a three-bit temporal_id indication for temporal level and a five-bit reserved field (called reserved_one_{—}5 bits) required to have a value equal to 1 in a draft HEVC standard. The temporal_id syntax element may be regarded as a temporal identifier for the NAL unit.

The five-bit reserved field is expected to be used by extensions such as a future scalable and 3D video extension. It is expected that these five bits would carry information on the scalability hierarchy, such as quality_id or similar, dependency_id or similar, any other type of layer identifier, view order index or similar, view identifier, an identifier similar to priority_id of SVC indicating a valid sub-bitstream extraction if all NAL units greater than a specific identifier value are removed from the bitstream. Without loss of generality, in some example embodiments a variable LayerId is derived from the value of reserved_one_{—}5 bits, which may also be referred to as layer_id_plus1, for example as follows: LayerId=reserved_one_{—}5 bits−1.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU. In H.264/AVC and HEVC a coded slice NAL unit can be indicated to be a coded slice in an Instantaneous Decoding Refresh (IDR) picture or coded slice in a non-IDR picture. In HEVC, a coded slice NAL unit can be indicated to be a coded slice in a Clean Decoding Refresh (CDR) picture (which may also be referred to as a Clean Random Access picture or a CRA picture).

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. In a draft HEVC standard a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In a draft HEVC, there is also a third type of parameter sets, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), adaptive sample offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS. In another draft HEVC standard, an APS syntax structure only contains ALF parameters. In a draft HEVC standard, an adaptation parameter set RBSP includes parameters that can be referred to by the coded slice NAL units of one or more coded pictures when at least one of sample_adaptive_offset_enabled_flag or adaptive_loop_filter_enabled_flag are equal to 1.

A draft HEVC standard also includes a fourth type of a parameter set, called a video parameter set (VPS), which was proposed for example in document JCTVC-H0388 (http://phenix.int-evry.fr/jct/doc_end_user/documents/8_San %20Jose/wg11/JCTVC-H0388-v4.zip). A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3DV. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. In a scalable extension of HEVC, VPS may for example include a mapping of the LayerId value derived from the NAL unit header to one or more scalability dimension values, for example correspond to dependency_id, quality_id, view_id, and depth_flag for the layer defined similarly to SVC and MVC. VPS may include profile and level information for one or more layers as well as the profile and/or level for one or more temporal sub-layers (consisting of VCL NAL units at and below certain temporal_id values) of a layer representation.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a HEVC standard, a slice header additionally contains an APS identifier. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A parameter sets may be activated by a reference from a slice or from another active parameter set or in some cases from another syntax structure such as a buffering period SEI message.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC. The NAL unit header indicates the type of the NAL unit and whether a coded slice contained in the NAL unit is a part of a reference picture or a non-reference picture.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in a draft HEVC standard, a combined list (List C) is constructed after the final reference picture lists (List 0 and List 1) have been constructed. The combined list may be used for uni-prediction (also known as uni-directional prediction) within B slices.

A reference picture list, such as reference picture list 0 and reference picture list 1, is typically constructed in two steps: First, an initial reference picture list is generated. The initial reference picture list may be generated for example on the basis of frame_num, POC, temporal_id, or information on the prediction hierarchy such as GOP structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

Scalable video coding refers to coding structure where one bitstream can contain multiple representations of the content at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

In some scalable video coding schemes, a video signal can be encoded into a base layer and one or more enhancement layers. An enhancement layer may enhance the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Some coding standards allow creation of scalable bit streams. A meaningful decoded representation can be produced by decoding only certain parts of a scalable bit stream. Scalable bit streams can be used for example for rate adaptation of pre-encoded unicast streams in a streaming server and for transmission of a single bit stream to terminals having different capabilities and/or with different network conditions. A list of some other use cases for scalable video coding can be found in the ISO/IEC JTC1 SC29 WG11 (MPEG) output document N5540, “Applications and Requirements for Scalable Video Coding”, the 64^{th} MPEG meeting, Mar. 10 to 14, 2003, Pattaya, Thailand.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS).

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop is needed for decoding of most pictures, while a second decoding loop is selectively applied to reconstruct the base representations, which are needed as prediction references but not for output or display, and are reconstructed only for the so called key pictures (for which “store_ref_base_pic_flag” is equal to 1).

FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

The scalability structure in the SVC draft may be characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL−1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref_base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_refactive_{—}1x_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

A scalable video codec for quality scalability (also known as Signal-to-Noise or SNR) and/or spatial scalability may be implemented as follows. For a base layer, a conventional non-scalable video encoder and decoder are used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use typically with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability following scalability modes exist:
Spatial scalability: Base layer pictures are coded at a higher resolution than enhancement layer pictures.
Bit-depth scalability: Base layer pictures are coded at lower bit-depth (e.g. 8 bits) than enhancement layer pictures (e.g. 10 or 12 bits).
Chroma format scalability: Base layer pictures provide higher fidelity in chroma (e.g. coded in 4:4:4 chroma format) than enhancement layer pictures (e.g. 4:2:0 format).

In all of the above scalability cases, base layer information could be used to code enhancement layer to minimize the additional bitrate overhead. Nevertheless, the existing solutions for scalable video coding do not take full advantage of the information available from the base layer and from the enhancement layer when encoding and decoding the enhancement layer.

Now in order to enhance the performance of the enhancement layer motion compensated prediction, an improved method for the prediction of enhancement layer samples is presented hereinafter.

In the method, a block of samples to be predicted in the enhancement layer picture are identified. A first enhancement layer prediction block is calculated by performing a motion compensated prediction for the identified block of samples using at least one enhancement layer reference picture and enhancement layer motion information. The steps are repeated on a base layer; i.e. a block of reconstructed samples is identified in a base layer picture co-locating with the block of samples to be predicted in the enhancement layer picture, and a base layer prediction block is calculated by performing a motion compensated prediction for the identified block of reconstructed samples using at least one base layer reference picture and the motion information indicated for the enhancement layer. A second enhancement layer prediction is then calculated based on the base layer prediction block, the identified base layer reconstructed samples and the first enhancement prediction. The identified block of samples in the enhancement layer picture is encoded by predicting from the second enhancement layer prediction.

According to an embodiment, the method further comprises identifying a residual signal between the values of the block of samples in an original picture and the values of the co-located enhancement layer prediction block; coding the residual signal into a reconstructed residual signal; and adding the reconstructed residual signal to the co-located enhancement layer prediction block.

Thus, the performance of the enhancement layer motion compensated prediction is improved by adding together the enhancement layer motion compensated prediction and a differential signal estimated by a motion compensation process on the base layer using the same or similar motion vector of enhancement layer. The differential signal approximates the residual signal on the base layer (i.e. appearing or disappearing objects in the video sequence) and may significantly reduce the need for residual prediction error coding on the enhancement layer, thus resulting in sizable compression efficiency gains.

The method may be referred to as base enhanced motion compensated prediction (BEMCP).

According to an embodiment, indication of the inter prediction modes and corresponding motion vectors and reference frame indexes is carried out similarly to the HEVC.

According to an embodiment, the usage of the BEMCP method is signaled at Prediction Unit (PU) level by a one-bin identifier.

According to an embodiment, the blocks in the base layer are generated by upsampling samples of the base layer picture to have the same spatial resolution as the enhancement layer prediction block. In this case the relationship of the coordinates of the P(x,y) and B(xb,yb) becomes straightforward: xb=x, yb=y.

According to an embodiment, the motion compensated prediction in the base layer is created using the at least one base layer reference picture upsampled to the same spatial resolution as the enhancement layer prediction block. As a result, the enhancement layer motion information can be directly applied to the base layer motion compensation.

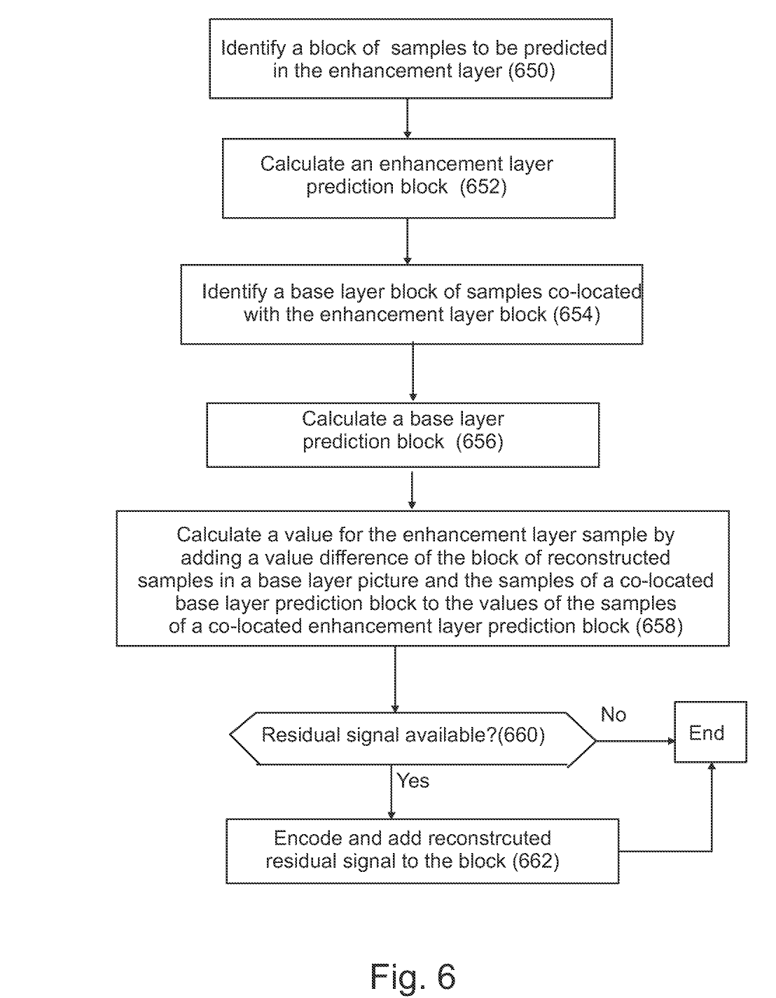

An embodiment for coding or decoding of a block of pixels in the enhancement layer (an enhancement layer block) is illustrated in the flow chart of FIG. 6. First, a block of samples to be predicted P(x,y) in the enhancement layer picture is identified (650). Then a motion compensated prediction is created for the identified block of samples P(x,y) using the enhancement layer reference pictures and enhancement layer motion information indicated in the coding/decoding process, thereby enabling to calculate an enhancement layer prediction block P′(x,y) (652). Repeating the steps in the base layer involves identifying a block of reconstructed base layer samples B(xb,yb) at the position corresponding to the location of the block of samples P(x,y) (654) and creating a motion compensated prediction for the identified block of samples B(xb,yb) using the base layer reference pictures and the indicated enhancement layer motion information, thus enabling to calculate a base layer prediction block B′(xb,yb) (656). Then the predicted values for the identified enhancement layer block of samples P(x,y) are calculated by adding the difference of B(xb,yb) and B′(xb,yb) to the P′(x,y) (658): i.e. P(x,y)=Clip (P′(x,y)+B(xb,yb)−B′(xb,yb)), where the Clip( ) function may be used to restrict the resulting sample value to the desired bit depth of the video material (e.g. between 0 and 255, inclusive, for 8-bit video). Finally, it is checked (660) whether there is left any residual signal, i.e. difference between the original image block and the enhancement layer prediction block. If yes, the residual signal is encoded and the reconstructed residual signal is added (662) to the enhancement layer prediction block.

A skilled man readily appreciates that the order of the above steps may vary. For example, the steps 500 and 502 may be carried out after the steps 504 and 506. Also different approaches can be used to perform the calculating the predicted values in step 508. For example, the difference of B(xb,yb) and B′(xb,yb) may be scaled by scaling factor.

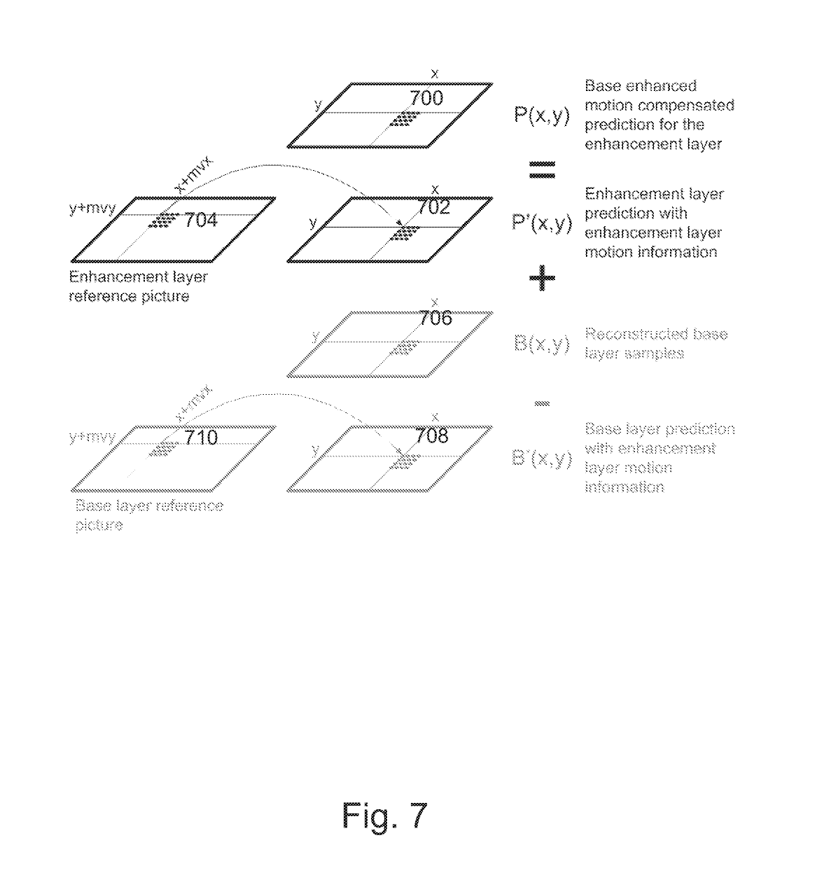

FIG. 7 illustrates an example of the BEMCP process in the case of uni-prediction (utilizing one motion vector with a single reference frame). The block of samples to be predicted P(x,y) in the enhancement layer picture 700 is shown as a shaded 4×4 block. An enhancement layer prediction block P′(x,y) in the predicted enhancement layer picture 702 is calculated from the corresponding block of the enhancement layer reference picture 704, using enhancement layer motion information; i.e. motion vector (mvx, mvy).

In the example of FIG. 6, the reconstructed base layer picture and the base layer reference pictures have been upsampled to have the spatial resolution of the enhancement picture. Thus, the enhancement layer motion vector (mvx, mvy) is applied without modifications when performing the motion compensation operation at the base layer.

A block of reconstructed base layer samples B(x,y) at the position corresponding to the location of the block of samples P(x,y) is identified in the reconstructed base layer picture 706. A base layer prediction block B′(x,y) in the predicted base layer picture 708 is calculated from the corresponding block of the base layer reference picture 710, using the motion vector (mvx, mvy).

Once the motion compensated predictions have been performed the enhancement layer prediction samples are obtained by evaluating the equation:

P(x,y)=Clip(P′(x,y)+B(x,y)−B′(x,y))

The embodiments may be carried out as computer code, stored for example on a computer readable storage medium or in a memory, which code when executed by a processor, causes an apparatus, such as a mobile phone, to perform the necessary steps. For example, calculating predicted values for the identified enhancement layer block of samples can be implemented as C/C++ code e.g. as follows:

----
for (Int y = 0; y < iHeight;y++)

for (Int x = 0; x < iWidth;x++)

pEnh[y*iStrideEnh + x] = Clip ( pEnh[y*iStrideEnh + x] +

pBaseThis[y*iStrideBaseThis + x] − pBase[y*iStrideBase + x]);
----

where (iWidth, iHeight) defines the size of an enhancement layer prediction block. pEnh is a pointer to an array containing the generated motion compensated prediction for an enhancement layer block P′(x,y) as an input and the final base enhanced motion compensated prediction P(x,y) as an output. pBaseThis is a pointer to an array containing the upsampled base layer reconstructed image B(x,y) with the same resolution as the enhancement layer image. bBase is a pointer to the motion compensated base layer block B′(x,y) that was obtained by utilizing the enhacement layer motion information similarly to P′(x,y). iStrideEnh, iStrideBaseThis and iStrideBase refer to the width of the buffers containing the sample data for pEnh, pBaseThis and pBase, respectively.

According to an embodiment, signaling of the usage of the BEMCP mode is not limited to signaling at Prediction Unit (PU) level only, but can be performed at different granularity, for example at Coding Unit (CU), slice, picture or sequence level.

As mentioned above, the difference of B(x,y) and B′(x,y) may be scaled by scaling factor. According to an embodiment, scaling of the differential term B(x,y)−B′(x,y) may vary and the scale factor may be signaled indicating the selected scaling operation. For example, a one bin identifier can be used to indicate whether the differential term is scaled by a predefined factor or used without scaling. The predefined factor could be e.g. 0.5, giving two alternative predictions P1(x,y) and P2(x,y) as follows:

P1(x,y)=Clip(P′(x,y)+B(x,y)−B′(x,y));

P2(x,y)=Clip(P′(x,y)+((B(x,y)−B′(x,y))>>1)

According to an embodiment, a plurality of scaling factors may be used and thereby also the differential term P′(x,y)−B′(x,y) may be scaled. For example, allowing both P′(x,y)−B′(x,y) and B(x,y)−B′(x,y) be scaled by a factor of 0.5, three BEMCP modes may be generated. In this example, one bin may indicate if the non-scaled BEMCP is used or not, and in the case a scaled BEMCP is used, another bin may indicate which one of the two scaled BEMCP modes is enabled for a block of pixels:

P1(x,y)=Clip(P′(x,y)+B(x,y)−B′(x,y));

P2(x,y)=Clip(P′(x,y)+((B(x,y)−B′(x,y))>>1);

P3(x,y)=Clip(B(x,y)+((P′(x,y)−B′(x,y))>>1)

According to an embodiment, the scaling factors for the differential terms P′(x,y)−B′(x,y) and B(x,y)−B′(x,y) can be either signaled or implied from available information. The values of the scaling factors may be either limited to range between 0 and 1 inclusive, or may have values outside of that range.

According to an embodiment, the usage of the BEMCP mode may depend on the type of the block (inter, intra, uni-predicted, bi-predicted, etc.) or picture (I, P, B picture, reference or non-reference picture, position of the picture in the temporal hierarchy, etc.) or block size.

According to an embodiment, the usage of the BEMCP mode may depend on the availability of the base layer information for the current picture or for the temporal reference pictures.

According to an embodiment, the usage of the BEMCP mode may depend on the bitrate, quantization parameter utilized for the block or chromacity of the block.

Instead of or in addition to signaling the usage of the BEMCP mode, the BEMCP mode may be enabled by inferring the usage information with pre-determined conditions or as a combination of these approaches. According to an embodiment, inferring the usage of the mode may take place e.g. based on the modes of the neighboring blocks, based on presence of prediction error coding on the base layer block(s) with location corresponding to the enhancement layer block, based on the sample values of the enhancement layer or base layer reference frames or sample values of the reconstructed base layer picture, availability of the base layer reference picture in the base layer decoded picture buffer or a combination of these.

According to an embodiment, the usage of the BEMCP mode may differ with respect to the type of motion coding mechanism. For example in HEVC, using the mode may be explicitly signaled for AMVP coded blocks and using the mode may be copied from the mode information of the selected merge candidate in the merge coded blocks.

In the upsampling of the base layer, different upsampling filters may be utilized. The upsampling of the base layer may be done either for a complete picture or only for the area that is required for the motion compensation/BEMCP process (or an area in between).

According to an embodiment, the coordinate systems of the enhancement and base layer images may be different. For example, if the base layer is not upsampled to the same resolution with enhancement layer prior to processing, but there is a spatial scalability of 2:1 between the base layer and enhancement layer, the relationship of coordinates of the base and enhancement layer samples P and B may be given as xb=x/2, yb=y/2.

According to an embodiment, motion compensation in the base layer may take place at the original resolution of the base layer. The base layer difference signal Bd(xb,yb)=B(xb,yb)−B′(xb,yb) at the original resolution may be upsampled to the same resolution with enhancement layer block and added to the enhancement layer prediction: P(x,y)=P′(x,y)+Bdupsampled(x,y). Herein, the base layer motion compensation should scale the enhancement layer motion vectors to match the difference in resolutions of the two layers.

According to an embodiment, instead of applying motion compensated prediction in the base layer the indicated base layer prediction error signal may be upsampled and applied as the estimated prediction error signal for the enhancement layer: P(x,y)=P′(x,y)+UpsampledBasePredictionError (x,y)

According to an embodiment, instead of utilizing reconstructed base layer samples, intermediate samples prior to reconstruction could be used for obtaining the difference values. Especially, base layer values prior to any in-loop filtering operations, such as deblocking filtering or Sample Adaptive Offset (SAO) and Adaptive Loop Filter (ALF) of HEVC, may be used.

According to an embodiment, the motion compensation process at the base layer may be limited in order to lower the memory bandwidth requirements of the method. For example, the process may be limited to uni-prediction (utilizing e.g. only list 0 enhancement layer motion, or enhancement layer motion vector which refers to the closest reference frame in time or picture order sense), quantizing the base layer motion vectors to full pixel values, or utilizing the mode only if the enhancement layer motion is close (e.g. within a certain pre-defined or indicated horizontal and vertical range) to the motion that has been indicated for the base layer for the base layer motion compensated prediction. When the enhancement layer motion is close to the motion that has been indicated for the base layer, a decoder may obtain a sample block from the base layer reference frame, the size of which is increased on the basis of the pre-defined or indicated horizontal and vertical range for example using one memory fetch operation. Consequently, the number of memory fetch operations from the decoded picture buffer may be reduced. The encoder may indicate the horizontal and/or vertical range of the enhancement layer motion relative to the base layer motion for example in a sequence parameter set.

According to an embodiment, the motion compensation process at the base layer may utilize the motion information indicated to be used for the base layer reconstruction process instead or in addition to the enhancement layer motion information.

According to a further embodiment to limit memory bandwidth requirements, the method may be applied for only blocks with dimensions smaller or larger than a predetermined value (e.g. 4, 8, 16 or 32 pixels).

According to an embodiment, the decision to use the BEMCP enhancement may be done separately for each pixel in the block by analyzing the pixel values of P′(x,y), B(x,y) and B′(x,y). Herein,
decision for each pixel may be explicitly signaled;
rather than pixel level granularity, different sizes of sub-blocks may be used for analysis/signaling;
the analysis may consider any two of the blocks among P′(x,y), B(x,y) and B′(x,y);
the analysis may be based on thresholding absolute difference of any two of the blocks among P′(x,y), B(x,y) and B′(x,y). For example, the following analysis may be applied for each pixel at location x,y:
   Pick P′(x,y) of abs(P′(x,y)−B(x,y))<T,
   pick B(x,y) otherwise, (or vice versa),
   where T is a predetermined or adaptive threshold value.
the analysis may be as follows: For each pixel at location x,y: Pick P′(x,y) if abs(B′(x,y)−B(x,y))<abs(B′(x,y)−P′(x,y)), otherwise pick B(x,y), or vice versa.
during the evaluation of P(x,y)=Clip (P′(x,y)+B(xb,yb)−B′(xb,yb)), either the absolute value of B(xb,yb)−B′(xb,yb) or absolute value of P′(xb,yb)−B′(xb,yb) may be clipped to a predetermined or adaptive value.

In various alternatives above, the use and/or the presence of BEMCP related syntax element(s) or syntax element values may depend on the availability (as reference for prediction) of base layer reference picture(s) corresponding to the enhancement layer reference picture(s). The encoder may control the availability through reference picture sets for the base layer (and consequently reference picture marking for inter prediction of the base layer) and/or specific reference picture marking control for BEMCP or for inter-layer prediction in general. The encoder and/or the decoder may set the inter-layer marking status of a base layer (BL) picture as “used for BEMCP reference” or “used for inter-layer reference” or alike when it is concluded that the BL picture is or may be needed as a BEMCP reference or an inter-layer prediction reference for an enhancement layer (EL) picture and as “unused for BEMCP reference” or “unused for inter-layer reference” or alike when it is concluded that the BL picture is not needed as a BEMCP reference or an inter-layer prediction reference for an EL picture.

The encoder may generate specific reference picture set (RPS) syntax structure for inter-layer referencing or a part of another RPS syntax structure dedicated for inter-layer references. The syntax structure for inter-layer RPS may be appended to support inter-RPS prediction. As with other RPS syntax structures, each one of the inter-layer RPS syntax structures may be associated with an index and an index value may be included for example in a coded slice to indicate which inter-layer RPS is in use. The inter-layer RPS may indicate the base layer pictures, which are marked as “used for inter-layer reference”, while any base layer pictures not in the inter-layer RPS referred to be an EL picture may be marked as “unused for inter-layer reference”.

Alternatively or additionally, there may be other means to indicate if a BL picture is used for inter-layer reference, such as a flag in a slice extension of a coded slice of the BL picture or in a coded slice of the respective EL picture. Furthermore, there may be one or more indications indicating the persistence of marking a BL picture as “used for inter-layer reference”, such as a counter syntax element in a sequence level syntax structure, such as a video parameter set, and/or in a picture or slice level structure, such as a slice extension. A sequence-level counter syntax element may for example indicate a maximum POC value difference of any EL motion vector that uses BEMCP and/or a maximum number of BL pictures (which may be at the same or lower temporal sub-layer) in decoding order over which the BL picture is marked as “used for inter-layer reference” (by the encoding and/or decoding process). A picture-level counter may for example indicate the number of BL pictures (which may be at the same or lower temporal sub-layer as the BL picture including the counter syntax element) in decoding order over which the BL picture is marked as “used for inter-layer reference” (by the encoding and/or decoding process).

Alternatively or additionally, there may be other means to indicate which BL pictures are or may be used for inter-layer reference. For example, there may be a sequence-level indication, for example in a video parameter set, which temporal_id values and/or picture types in the base layer may be used as inter-layer reference, and/or which temporal_id values and/or picture types in the base layer are not used as inter-layer reference.

The decoded picture buffering (DPB) process may be modified in a manner that pictures, which are “used for reference” (for inter prediction), needed for output, or “used for inter-layer reference” are kept in the DPB, while pictures which are “unused for reference” (for inter prediction), not needed for output (i.e. have already been output or were not intended for output in the first place), and are “unused for inter-layer reference” may be removed from the DPB.

A decoder decoding only the base layer may omit processes related to marking of pictures as inter-layer references, e.g. decoding of the inter-layer RPS, and hence treat all pictures as if they are “unused for inter-layer reference”.

The above-described method can be applied to any video stream containing more than one representations of the content. For example, it can be applied to multi-view video coding utilizing possibly processed images from different views as the base images.

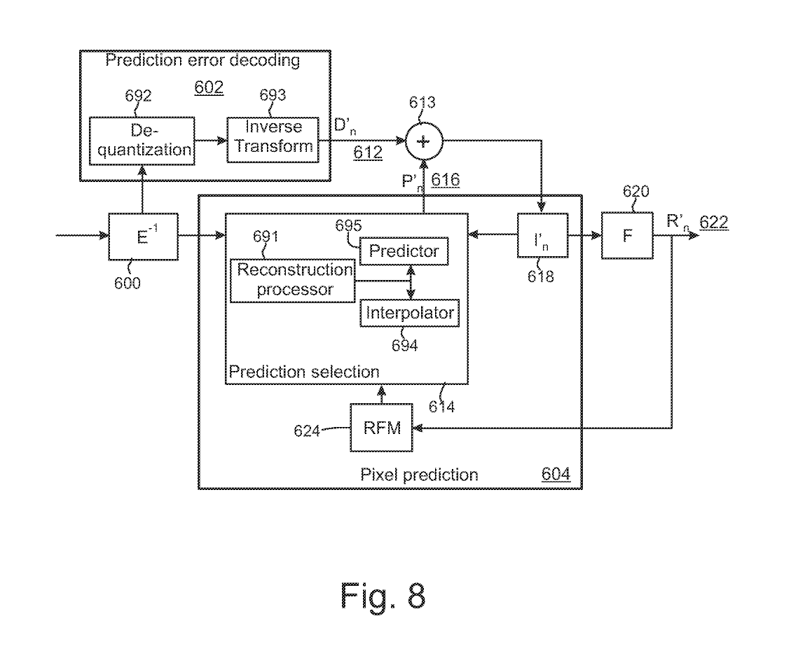

Another aspect of the invention is operation of the decoder when it receives the base-layer picture and at least one enhancement layer picture. FIG. 8 shows a block diagram of a video decoder suitable for employing embodiments of the invention.

The decoder includes an entropy decoder 600 which performs entropy decoding on the received signal as an inverse operation to the entropy encoder 330 of the encoder described above. The entropy decoder 600 outputs the results of the entropy decoding to a prediction error decoder 602 and pixel predictor 604.

The pixel predictor 604 receives the output of the entropy decoder 600. A predictor selector 614 within the pixel predictor 604 determines that an intra-prediction, an inter-prediction, or interpolation operation is to be carried out. The predictor selector may furthermore output a predicted representation of an image block 616 to a first combiner 613. The predicted representation of the image block 616 is used in conjunction with the reconstructed prediction error signal 612 to generate a preliminary reconstructed image 618. The preliminary reconstructed image 618 may be used in the predictor 614 or may be passed to a filter 620. The filter 620 applies a filtering which outputs a final reconstructed signal 622. The final reconstructed signal 622 may be stored in a reference frame memory 624, the reference frame memory 624 further being connected to the predictor 614 for prediction operations.

The prediction error decoder 602 receives the output of the entropy decoder 600. A dequantizer 692 of the prediction error decoder 602 may dequantize the output of the entropy decoder 600 and the inverse transform block 693 may perform an inverse transform operation to the dequantized signal output by the dequantizer 692. The output of the entropy decoder 600 may also indicate that prediction error signal is not to be applied and in this case the prediction error decoder produces an all zero output signal.

The decoding operations of the embodiments are similar to the encoding operations, shown e.g. in FIG. 6. Thus, in the above process, the decoder may first identify a block of samples to be predicted in the enhancement layer picture. Then the decoder may calculate a first enhancement layer prediction block by performing a motion compensated prediction for the identified block of samples using at least one enhancement layer reference picture and enhancement layer motion information obtained from the encoder. The decoder may the repeat the steps on a base layer; i.e. a block of reconstructed samples is identified in a base layer picture co-locating with the block of samples to be predicted in the enhancement layer picture, and a base layer prediction block is calculated by performing a motion compensated prediction for the identified block of reconstructed samples using at least one base layer reference picture and the motion information indicated for the enhancement layer. The decoder then calculates a second enhancement layer prediction on the base layer prediction block, the identified base layer reconstructed samples and the first enhancement prediction. The identified block of samples in the enhancement layer picture is decoded by predicting from the second enhancement layer prediction.

If there is a residual signal resulting from the decoding of the block of samples, the decoder then decodes the residual signal into a reconstructed residual signal and adds the reconstructed residual signal to the decoded block in the enhancement layer picture.

In the above, some embodiments have been described with reference to an enhancement layer and a base layer. It needs to be understood that the base layer may as well be any other layer as long as it is a reference layer for the enhancement layer. It also needs to be understood that the encoder may generate more than two layers into a bitstream and the decoder may decode more than two layers from the bitstream. Embodiments could be realized with any pair of an enhancement layer and its reference layer. Likewise, many embodiments could be realized with consideration of more than two layers.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some or all common elements.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

A method according to a first embodiment comprises a method for encoding a block of samples in an enhancement layer picture, the method comprising
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to an embodiment, the method further comprises
identifying a residual signal between the values of the block of samples in an original picture and the values of the second enhancement layer prediction;
coding the residual signal into a reconstructed residual signal; and
adding the reconstructed residual signal to the second enhancement layer prediction.

According to an embodiment, indication of the inter prediction modes and corresponding motion vectors and reference frame indexes is carried out similarly to the HEVC.

According to an embodiment, the blocks in the base layer are generated by upsampling samples of the base layer picture to have the same spatial resolution as the enhancement layer prediction block.

According to an embodiment, the base layer motion compensated prediction and deduction of the base layer motion compensated prediction from the base layer reconstructed samples is performed prior to upsampling the difference and adding it to the enhancement layer prediction.

According to an embodiment, the motion compensated prediction in the base layer is created using the at least one base layer reference picture upsampled to the same spatial resolution as the enhancement layer prediction block.

According to an embodiment, the difference of the block of reconstructed samples in a base layer picture and the samples of a co-located base layer prediction block is scaled by at least one scaling factor.

According to an embodiment, the said scaling factor is signaled in the bitstream.

According to an embodiment, a number of predefined scaling factors are used and the scaling factors are indicated in the bitstream.

According to an embodiment, if coordinate systems of the enhancement and base layer images are different, a difference in a spatial scalability between the base layer and enhancement layer is taken into account, when defining a relationship of coordinates of the base and enhancement layer samples.

According to an embodiment, the enhancement layer motion information is scaled to match the difference in a spatial scalability between the base layer and enhancement layer prior to performing the base layer motion compensated prediction.

According to an embodiment, using intermediate samples prior to reconstruction, instead of reconstructed base layer samples, for obtaining the difference values.

According to an embodiment, using base layer values prior to in-loop filtering operations, such as deblocking filtering or Sample Adaptive Offset (SAO) and Adaptive Loop Filter (ALF).

According to an embodiment, the method is applied always as a default setting.

According to an embodiment, the method is enabled selectively by signaling a flag to the decoder.

According to an embodiment, the method is enabled by signaling a one-bin identifier at Prediction Unit (PU) level

According to an embodiment, the method is enabled when pre-determined conditions are met, such as based on the modes of the neighboring blocks, based on presence of prediction error coding on the base layer block(s) with location corresponding to the enhancement layer block, based on the sample values of the enhancement layer or base layer reference frames or sample values of the reconstructed base layer picture, availability of the base layer reference picture in the base layer decoded picture buffer or a combination of these.

An apparatus according to a second embodiment comprises:
a video encoder configured for encoding a scalable bitstream comprising a base layer and at least one enhancement layer, wherein said video encoder is further configured for
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to a third embodiment there is provided a computer readable storage medium stored with code thereon for use by an apparatus, which when executed by a processor, causes the apparatus to perform:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to a fourth embodiment there is provided at least one processor and at least one memory, said at least one memory stored with code thereon, which when executed by said at least one processor, causes an apparatus to perform:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

A method according to a fifth embodiment comprises a method for decoding a scalable bitstream comprising a base layer and at least one enhancement layer, the method comprising
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture; and
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

According to an embodiment, the method further comprises
identifying a residual signal between the values of the block of samples in an original picture and the values of the second enhancement layer prediction;
decoding the residual signal into a reconstructed residual signal; and
adding the reconstructed residual signal to second enhancement layer prediction.

According to an embodiment, indication of the inter prediction modes and corresponding motion vectors and reference frame indexes is carried out similarly to the HEVC.

According to an embodiment, the blocks in the base layer are generated by upsampling samples of the base layer picture to have the same spatial resolution as the enhancement layer prediction block.

According to an embodiment, the base layer motion compensated prediction and deduction of the base layer motion compensated prediction from the base layer reconstructed samples is performed prior to upsampling the difference and adding it to the enhancement layer prediction.

According to an embodiment, the motion compensated prediction in the base layer is created using the at least one base layer reference picture upsampled to the same spatial resolution as the enhancement layer prediction block.

According to an embodiment, the difference of the block of reconstructed samples in a base layer picture and the samples of a co-located base layer prediction block is scaled by at least one scaling factor.

According to an embodiment, the said scaling factor is signaled in the bitstream.

According to an embodiment, a number of predefined scaling factors are used and the scaling factors are indicated in the bitstream.

According to an embodiment, if coordinate systems of the enhancement and base layer images are different, a difference in a spatial scalability between the base layer and enhancement layer is taken into account, when defining a relationship of coordinates of the base and enhancement layer samples.

According to an embodiment, the enhancement layer motion information is scaled to match the difference in a spatial scalability between the base layer and enhancement layer prior to performing the base layer motion compensated prediction.

According to an embodiment, using intermediate samples prior to reconstruction, instead of reconstructed base layer samples, for obtaining the difference values.

According to an embodiment, using base layer values prior to in-loop filtering operations, such as deblocking filtering or Sample Adaptive Offset (SAO) and Adaptive Loop Filter (ALF).

According to an embodiment, the method is applied always as a default setting.

According to an embodiment, the method is enabled selectively upon reception of a flag.

According to an embodiment, the method is enabled upon reception of a one-bin identifier at Prediction Unit (PU) level.

According to an embodiment, the method is enabled when pre-determined conditions are met, such as based on the modes of the neighboring blocks, based on presence of prediction error coding on the base layer block(s) with location corresponding to the enhancement layer block, based on the sample values of the enhancement layer or base layer reference frames or sample values of the reconstructed base layer picture, availability of the base layer reference picture in the base layer decoded picture buffer or a combination of these.

An apparatus according to a sixth embodiment comprises:
a video decoder configured for decoding a scalable bitstream comprising a base layer and at least one enhancement layer, the video decoder being configured for
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

According to a seventh embodiment there is provided a video encoder configured for encoding a scalable bitstream comprising a base layer and at least one enhancement layer, wherein said video encoder is further configured for:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture; and
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

According to an eighth embodiment there is provided a video decoder configured for decoding a scalable bitstream comprising a base layer and at least one enhancement layer, wherein said video decoder is further configured for:
identifying a block of samples to be predicted in the enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture; and
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

1. A method comprising:
identifying a block of samples to be predicted in an enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

2. The method according to claim 1, the method further comprising
identifying a residual signal between the values of the block of samples in an original picture and the values of the second enhancement layer prediction;
decoding the residual signal into a reconstructed residual signal; and
adding the reconstructed residual signal to the second enhancement layer prediction.

3. The method according to claim 1, the method further comprising
generating a base layer block by upsampling samples of the base layer picture to have the same spatial resolution as an enhancement layer prediction block.

4. The method according to claim 3, the method further comprising
creating the motion compensated prediction in the base layer using the at least one base layer reference picture upsampled to the same spatial resolution as the enhancement layer prediction block.

5. The method according to claim 3, the method further comprising
scaling the difference of the block of reconstructed samples in a base layer picture and the samples of a co-located base layer prediction block by at least one scaling factor.

6. The method according to claim 1, the method further comprising
in response to coordinate systems of the enhancement and base layer pictures being different, defining a relationship of coordinates of the base and enhancement layer samples such that a difference in a spatial scalability between the base layer and enhancement layer is taken into account.

7. The method according to claim 6, the method further comprising
scaling the enhancement layer motion information to match the difference in a spatial scalability between the base layer and enhancement layer prior to performing the base layer motion compensated prediction.

8. An apparatus comprising:
at least one processor and at least one memory, said at least one memory stored with code thereon, which when executed by said at least one processor, causes the apparatus to perform:
identifying a block of samples to be predicted in an enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
decoding the identified block of samples in the enhancement layer picture by predicting from the second enhancement layer prediction.

9. The apparatus according to claim 8, the apparatus being further configured for
identifying a residual signal between the values of the block of samples in an original picture and the values of the second enhancement layer prediction;
decoding the residual signal into a reconstructed residual signal; and
adding the reconstructed residual signal to the second enhancement layer prediction.

10. The apparatus according to claim 8, the apparatus being further configured for
generating a base layer block by upsampling samples of the base layer picture to have the same spatial resolution as an enhancement layer prediction block.

11. The apparatus according to claim 9, the apparatus being further configured for
scaling the difference of the block of reconstructed samples in a base layer picture and the samples of a co-located base layer prediction block by at least one scaling factor.

12. The apparatus according to claim 8, the apparatus being further configured for
in response to coordinate systems of the enhancement and base layer pictures being different, defining a relationship of coordinates of the base and enhancement layer samples such that a difference in a spatial scalability between the base layer and enhancement layer is taken into account.

13. The apparatus according to claim 12, the apparatus being further configured for
scaling the enhancement layer motion information to match the difference in a spatial scalability between the base layer and enhancement layer prior to performing the base layer motion compensated prediction.

14. A method comprising:
identifying a block of samples to be predicted in an enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

15. The method according to claim 14, the method further comprising
identifying a residual signal between the values of the block of samples in an original picture and the values of the second enhancement layer prediction;
coding the residual signal into a reconstructed residual signal; and
adding the reconstructed residual signal to the second enhancement layer prediction.

16. The method according to claim 14, the method further comprising
generating a base layer block by upsampling samples of the base layer picture to have the same spatial resolution as an enhancement layer prediction block.

17. The method according to claim 16, wherein the method is enabled when a pre-determined condition is met, such as based on the modes of the neighboring blocks, based on presence of prediction error coding on the base layer block(s) with location corresponding to the enhancement layer block, based on the sample values of the enhancement layer or base layer reference frames or sample values of the reconstructed base layer picture, availability of the base layer reference picture in the base layer decoded picture buffer or a combination of these.

18. An apparatus comprising:
at least one processor and at least one memory, said at least one memory stored with code thereon, which when executed by said at least one processor, causes the apparatus to perform:
identifying a block of samples to be predicted in an enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

19. A video encoder configured for encoding a scalable bitstream comprising a base layer and at least one enhancement layer, wherein said video encoder is further configured for:
identifying a block of samples to be predicted in an enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
encoding the identified block of samples in the enhancement layer picture by predicting from the second enhancement layer prediction.

20. A video decoder configured for decoding a scalable bitstream comprising a base layer and at least one enhancement layer, wherein said video decoder is further configured for:
identifying a block of samples to be predicted in an enhancement layer picture;
calculating a first enhancement layer prediction block by performing a motion compensated prediction for the identified block of samples using at least one enhancement layer reference picture and enhancement layer motion information;
identifying a block of reconstructed samples in a base layer picture co-locating with the block of samples to be predicted in the enhancement layer picture;
calculating a base layer prediction block by performing a motion compensated prediction for the identified block of reconstructed samples using the enhancement layer motion information and at least one base layer reference picture;
calculating a second enhancement layer prediction based on the base layer prediction block, the identified base layer reconstructed samples and the first enhancement prediction; and
decoding the identified block of samples in the enhancement layer picture by predicting from the second enhancement layer prediction.
